(19) United States
(12) Patent Application Publication
(10) Pub. No.: US 2025/0277609 A1
(43) Pub. Date: Sep. 4, 2025

(54) HEAT PUMP WITH IMPROVED ENERGY EFFICIENCY

(71) Applicant: AWESOME LAB Co., Ltd., Seongnam-si (KR)

(72) Inventor: Dong Muk KIM, Seongnam-si (KR)

(73) Assignee: AWESOME LAB Co., Ltd., Seongnam-si (KR)

(21) Appl. No.: 18/950,304

(22) Filed: Nov. 18, 2024

(30) Foreign Application Priority Data
Mar. 4, 2024 (KR) 10-2024-0030685
May 23, 2024 (KR) 10-2024-0066830

(51) Int. Cl. F25B 30/00

(52) U.S. Cl. CPC F25B 30/00; F25B 2500/18

(57) ABSTRACT

The present disclosure relates to a heat pump including a power unit providing a rotational driving force for liquid circulation and receiving power to heat liquid, and a housing defining a space therein to allow the power unit to be disposed therein. The power unit may include a motor, a shaft connected to the motor to receive power, and a plurality of rotary bodies rotatably provided on the shaft to be spaced apart from each other. A first polarity or a second polarity different from the first polarity may be applied to each of the rotary bodies. Therefore, heating performance can be maximized.

### CROSS-REFERENCE TO RELATED APPLICATION(S)

This application claims benefit of priority to Korean Patent Application Nos. 10-2024-0030685 filed on Mar. 4, 2024 and 10-2024-0066830 filed on May 23, 2024 in the Korean Intellectual Property Office, the disclosure of which is incorporated herein by reference in its entirety.

### BACKGROUND

### 1. Field

The present disclosure relates to a heat pump with improved energy efficiency.

### 2. Description of Related Art

A heat pump is one of important devices used for heat transfer and temperature control in various industrial fields. The heat pump may be designed to efficiently transfer heat generated or absorbed from a heat generating or absorbing device and to deliver the heat to an external system in a controllable form.

The main applications of the heat pump are diverse, including temperature control in an industrial process, energy production and transmission, production and research in medical and pharmaceutical industries, and environmental testing and control. Due to these diverse applications, the heat pump should meet various size, capacity, and technical requirements.

A conventional heat pump usually includes a pump, a heat exchanger, a control device, and related components. However, the conventional heat pump often has limitations in terms of efficiency, reliability, and maintenance. In particular, some heat pumps may suffer from problems such as excessive energy consumption, unstable temperature control, and the possibility of failure.

Accordingly, an improvement in the heat pump is needed, which requires new technologies and design elements. Technical solutions are needed to improve the functionality of the heat pump in terms of improved heat transfer efficiency, stability and reliability, energy efficiency, and ease of maintenance.

To this end, various technical improvements have been recently proposed, which may include development in material engineering, innovation in a control system, and the introduction of efficient heat exchange technology. The technological development may offer the potential to improve the performance of the heat pump and meet the needs of a wide range of applications in industrial and technical fields.

### RELATED ART DOCUMENT

### Patent Document

(Patent Document 0001) Korean Patent Application Publication No. 10-2022-0072713

### SUMMARY

Embodiments of the present disclosure are to provide a heat pump, which includes a plurality of rotary bodies, thereby improving heating performance and energy efficiency.

Further, embodiments of the present disclosure are to provide a heat pump, in which the power of a first polarity is supplied to some of a plurality of rotary bodies and the power of a second polarity is supplied to the remaining rotary bodies to rotate the rotary bodies in opposing directions or selectively rotate the rotary bodies, thereby improving heating performance and energy efficiency.

Further, embodiments of the present disclosure are to provide a heat pump having improved heating performance and improved energy efficiency, through an optimal inlet structure into which housing liquid is introduced.

Further, embodiments of the present disclosure are to provide a heat pump, which opens a portion of a rotary body, thereby securing heating performance, allowing liquid to easily flow, and improving energy efficiency.

According to embodiments of the present disclosure, a heat pump with improved energy efficiency can heat and circulate liquid by applying different polarities to a portion of a power unit and the other portion of the power unit.

In an aspect, a heat pump may include a power unit providing a rotational driving force for liquid circulation and receiving power to heat liquid, and a housing defining a space therein to allow the power unit to be disposed therein.

The power unit may include a motor, a shaft connected to the motor to receive power, and a plurality of rotary bodies rotatably provided on the shaft to be spaced apart from each other, and a first polarity or a second polarity different from the first polarity may be applied to each of the plurality of rotary bodies.

Each of the rotary bodies may include a first impeller coupled to the shaft, the first polarity being applied thereto, and a second impeller disposed on the shaft to be spaced apart from the first impeller, the second polarity being applied thereto.

A plurality of first impellers may be arranged to be spaced apart from each other, and a plurality of second impellers may be arranged between the plurality of first impellers.

The first impeller may rotate independently from the second impeller, and the second impeller may rotate in a first direction or a second direction different from the first direction or stops, when the first impeller rotates in the first direction.

The housing may include a housing body provided to surround the power unit, a housing rear part positioned at a rear of the housing body to make the inside and outside of the housing body communicate with each other, allowing liquid to be introduced therein, and a housing front part positioned at a front of the housing body to make the inside and outside of the housing body communicate with each other, allowing the liquid introduced into the housing rear part to pass through the power unit and then be discharged to the outside.

The housing may include a housing body provided to surround the power unit, a plurality of housing inlets formed along a periphery of the housing body to be spaced apart from each other, and making the inside and outside of the housing body communicate with each other, thereby allowing liquid to be introduced, and a housing front part disposed at a front of the housing body to make the inside and outside of the housing body communicate with each other, thereby allowing the liquid introduced into the housing inlets to pass through the power unit and then flow out to the outside.

Each of the rotary bodies may include a rotary body part defining an external appearance, a rotary penetration part formed through a center of the rotary body part to be fitted over the shaft, a rotary outer part spaced apart from the rotary body part, and provided to surround the rotary body part, and a plurality of rotary blades provided between the rotary body part and the rotary outer part, and connecting the rotary body part and the rotary outer part, and at least a portion of the rotary blades may be closed.

The heat pump may further include a plurality of housing partition walls protruding from an inner surface of the housing to control a flow amount of liquid flowing inside the housing, the housing partition walls may protrude from the inner surface of the housing to be disposed between the plurality of rotary bodies, and the first polarity or the second polarity may be applied to the housing partition walls, and a polarity different from that of the housing partition walls may be applied to all of the plurality of rotary bodies.

The heat pump may further include a plurality of shaft partition walls protruding from the shaft to control a flow amount of the liquid flowing inside the housing, the shaft partition walls may protrude from an outer surface of the shaft to be disposed between the plurality of rotary bodies, and the first polarity or the second polarity may be applied to the shaft partition walls, and a polarity different from that of the shaft partition walls may be applied to all of the plurality of rotary bodies.

The heat pump may further include a housing slot provided on the inner surface of the housing to allow the plurality of rotary bodies to be detachably attached thereto, and the housing slot may be provided to surround an outer end of the rotary body.

The heat pump may further include a shaft slot provided on the outer surface of the shaft to allow the plurality of rotary bodies to be detachably attached thereto, and the shaft slot may be provided to surround a center of the rotary body.

The housing may include a housing body provided to surround the power unit, a housing front part disposed at a front of the housing body, a housing rear part disposed at a rear of the housing body, and a plurality of housing through holes formed through the housing body and the housing front part to allow liquid to flow into and out of the housing body.

The housing may include a housing body provided to surround the power unit, a housing recess formed by recessing toward the shaft on an outer surface of the housing body, and a plurality of housing inlet holes formed through the housing body and the housing recess to allow liquid to flow into and out of the housing body, and the housing inlet holes may be formed in a surface of the housing recess facing the rotary body.

Further, each of the rotary bodies may include a rotary body part defining an external appearance, a rotary penetration part formed through a center of the rotary body part to be fitted over the shaft, a rotary outer part spaced apart from the rotary body part and provided to surround the rotary body part, a plurality of rotary blades provided between the rotary body part and the rotary outer part and connecting the rotary body part and the rotary outer part, and a rotary support part provided to surround the rotary penetration part and protruding from a center of the rotary body part. The housing may include a housing body provided to surround the power unit, a housing front part disposed at a front of the housing body to close the housing body, an inner surface thereof facing the rotary support part, a housing rear part disposed at a rear of the housing body to close the housing body, and a housing extension extending from an inner surface of the housing front part toward the rotary penetration part to be disposed inside the rotary support part.

The housing may include a housing body provided to surround the power unit, a housing front part disposed at a front of the housing body to close the housing body, a housing rear part disposed at a rear of the housing body to close the housing body, and a housing waterproofing part disposed inside the housing body to surround the shaft, thereby separating the motor and the rotary body, and provided to seal the motor.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a perspective view of a heat pump according to an embodiment of the present disclosure.

FIG. 2 is a sectional view of the heat pump illustrated in FIG. 1.

FIG. 3 is a perspective view of a heat pump according to an embodiment of the present disclosure.

FIG. 4 is a sectional view of the heat pump illustrated in FIG. 3.

FIG. 5 is a front view of rotary bodies according to an embodiment of the present disclosure.

FIG. 6 is a diagram illustrating the arrangement of rotary bodies according to an embodiment of the present disclosure.

FIG. 7 is a diagram illustrating a state for coupling the rotary bodies according to an embodiment of the present disclosure to a shaft.

FIG. 8 is a diagram illustrating a heat pump including a housing partition wall according to an embodiment of the present disclosure.

FIG. 9 is a diagram illustrating a heat pump including a shaft partition wall according to an embodiment of the present disclosure.

FIG. 10 is a diagram illustrating a heat pump including a housing slot according to an embodiment of the present disclosure.

FIG. 11 is a diagram illustrating a heat pump including a shaft slot according to an embodiment of the present disclosure.

FIG. 12 is a sectional view of a heat pump according to an embodiment of the present disclosure.

FIG. 13 is a diagram illustrating a heat pump including a housing recess according to an embodiment of the present disclosure.

FIG. 14 is a perspective view illustrating a heat pump with a side of a housing being open, according to an embodiment of the present disclosure.

FIGS. 15A and 15B are diagrams illustrating a heat pump including a housing extension according to an embodiment of the present disclosure.

FIG. 16 is a diagram illustrating a heat pump including a housing waterproofing part according to an embodiment of the present disclosure.

FIGS. 17A and 17B are diagrams illustrating a heat pump including a double housing structure according to an embodiment of the present disclosure.

FIGS. 18A and 18B are diagrams illustrating a heat pump including a shock absorbing member or a linear driving part according to an embodiment of the present disclosure.

FIGS. 19A and 19B are diagrams illustrating a heat pump including an insulating part and a crank part according to an embodiment of the present disclosure.

FIG. 20 is a diagram illustrating a heat pump including a blade control part according to an embodiment of the present disclosure.

### DETAILED DESCRIPTION

Hereinafter, embodiments of the present disclosure will be described in detail with reference to the accompanying drawings such that those skilled in the art can easily practice the present disclosure.

However, the present disclosure may be implemented in various ways without being limited to particular embodiments described herein. In order to clearly explain the present disclosure in the drawings, parts that are not related to the explanation are omitted. Like reference numerals refer to like parts throughout various figures and embodiments of the present disclosure.

Herein, duplicate descriptions of identical components will be omitted.

It will be understood that when a component is referred to as being “coupled” or “connected” to another component, it may be directly coupled or connected to the other component or intervening components may be present therebetween. In contrast, it should be understood that when a component is referred to as being “directly coupled” or “directly connected” to another component, there are no intervening components present.

The terminology used herein is for the purpose of describing particular embodiments only and is not intended to be limiting.

Herein, the singular forms are intended to include the plural forms as well, unless the context clearly indicates otherwise.

It will be further understood that the terms “comprise”, “include”, “have”, etc. when used in this specification, specify the presence of stated features, integers, steps, operations, components, components, and/or combinations thereof but do not preclude the presence or addition of one or more other features, integers, steps, operations, components, components, and/or combinations thereof.

Further, in this specification, the term “and/or” includes a combination of multiple listed items or any one of multiple listed items. In this specification, “A or B” may include “A”, “B”, or “both A and B”.

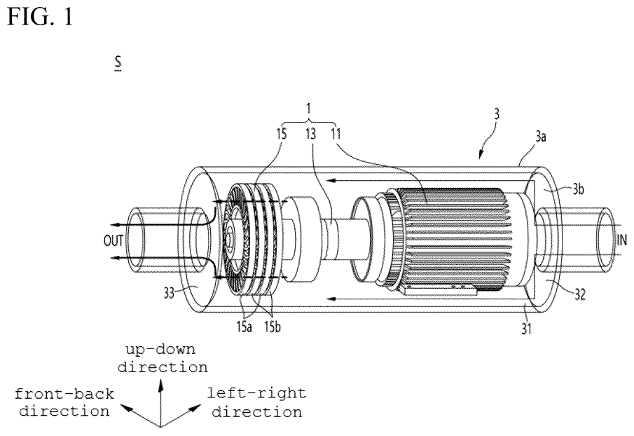

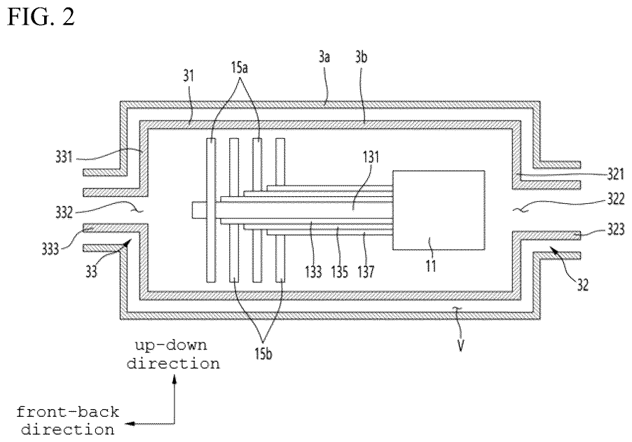

FIG. 1 is a perspective view of a heat pump according to an embodiment of the present disclosure. FIG. 2 is a sectional view of the heat pump illustrated in FIG. 1. Referring to FIGS. 1 and 2, a heat pump S according to an embodiment of the present disclosure may include a power unit 1 and a housing 3.

The power unit 1 may provide a rotational driving force for liquid circulation, and may be provided to receive power and heat liquid. That is, the power unit 1 may generate a rotational force by receiving power and circulate liquid through the rotational force.

Further, the power unit 1 may receive different polarities for some components and the remaining components in an overall configuration, allowing them to heat the liquid. The power applied by the power unit 1 is a general AC power source, and may be converted alternately between positive and negative single-polarity power. That is, polarity may mean either (+) polarity and (−) polarity.

The housing 3 has a space therein to allow the power unit 1 to be disposed therein. That is, the housing 3 allows liquid to be introduced, be heated by the power unit 1, and then be discharged to the outside.

Conventionally, a heating device and a circulation device are separately provided. However, the heat pump S according to an embodiment of the present disclosure can maximize space utilization efficiency by simultaneously performing heat generation and circulation through the power unit 1, and can directly circulate the heated liquid, thereby improving heat circulation speed.

Meanwhile, the housing 3 may be provided to receive power. That is, the housing 3 and the power unit 1 may be supplied with power of different polarities, and then heat liquid flowing therein due to a difference in polarity between the housing 3 and the power unit 1. That is, the housing 3 may receive power of a polarity opposite to that of at least a portion of the power unit 1 to heat liquid flowing therein. To be more specific, when the housing 3 and the power unit 1 contact the liquid flowing inside the housing 3, heat may be generated in the liquid between the power unit 1 and the inner surface of the housing 3 to which different polarities are applied.

Further, liquid can be rapidly and uniformly heated through the large area of the housing 3 and the power unit 1. Furthermore, the housing 3 and the power unit 1 may be made of a material having high conductivity so that current may flow therethrough. For instance, the housing 3 may be a conductor based on at least one of aluminum, copper, iron, and tungsten.

Further, the material of the housing 3 may be a material with high light transmittance so that the inside may be checked while allowing current to flow therethrough. For instance, the housing 3 may be formed of a transparent electrode including at least one of ITO, glass, aluminum, and carbon. Thus, a user can visually check the inside of the housing 3 to determine whether components accommodated therein are operated or are abnormal.

The housing 3 and the power unit 1 may be formed of a mixture of various materials. For instance, the housing 3 and the power unit 1 may be formed of a mixture of a conductor and a non-conductor. Therefore, the heat pump S according to an embodiment of the present disclosure may be configured so that only a conductive part of the housing 3 and the power unit 1 is energized when power is applied. That is, the housing 3 and the power unit 1 may be configured such that any area is divided into the conductor and the non-conductor, thereby allowing the location and degree of heat generation to be controlled. However, the material of the housing 3 and the power unit 1 is not limited thereto.

The power unit 1 may include a motor 11, a shaft 13, and a rotary body 15. The motor 11 may generate a rotational driving force. The shaft 13 may be connected to the motor 11 to receive power. That is, the shaft 13 may be rotatably connected to the motor 11.

A plurality of rotary bodies 15 may be rotatably provided on the shaft 13 to be spaced apart from each other. That is, the plurality of rotary bodies 15 may be provided on the shaft 13 to be spaced apart from each other. In other words, as the plurality of rotary bodies 15 are provided to be spaced apart from each other, a contact area with liquid flowing inside the housing 3 is maximized, and the circulation of liquid is promoted to maximize heating and heat circulation efficiency.

Further, a first polarity or a second polarity different from the first polarity may be applied to each of the plurality of rotary bodies 15. Thus, heat may be generated and liquid may be heated due to a difference in polarity between the plurality of rotary bodies 15. That is, the plurality of rotary bodies 15 may generate heat and may efficiently transfer the heat generated by rotation to the liquid.

To be more specific, the rotary body 15 may include a first impeller 15a and a second impeller 15b. The first impeller 15a may be coupled to the shaft 13 and may be applied with the first polarity. The second impeller 15b may be disposed on the shaft 13 to be spaced apart from the first impeller 15a, and may be applied with the second polarity different from the first polarity. If the first polarity is positive, the second polarity may be negative. If the first polarity is negative, the second polarity may be positive.

Meanwhile, the shaft 13 may be provided in a multi-stage structure. That is, a plurality of shafts 13 may be provided in a multi-stage structure to correspond to the number of rotary bodies 15. For instance, when two first impellers 15a are provided and two second impellers 15b are provided, four shafts 13 may be provided in a four-stage structure.

To be more specific, the shaft 13 may include a first shaft 131, a second shaft 133, a third shaft 135, and a fourth shaft 137. The first shaft 131 may be positioned at the innermost side to have the longest length, so that the first impeller 15a may be coupled to an end thereof. The second shaft 133 may surround the first shaft 131, and may be shorter in length than the first shaft 131 so that the second impeller 15b may be coupled to an end thereof. The third shaft 135 may surround the second shaft 133, and may be shorter in length than the second shaft 133 so that the first impeller 15a may be coupled to an end thereof. The fourth shaft 137 may surround the third shaft 135, and may be shorter in length than the third shaft 135 so that the second impeller 15b may be coupled to an end thereof.

The first shaft 131, the second shaft 133, the third shaft 135, and the fourth shaft 137 may independently rotate to independently rotate the first impeller 15a and the second impeller 15b and independently apply polarity to the first impeller 15a and the second impeller 15b. That is, the first polarity or the second polarity may be applied to the first impeller 15a coupled to the first shaft 131 through the motor 11 and the first shaft 131. The first polarity or the second polarity may be applied to the second impeller 15b coupled to the second shaft 133 through the motor 11 and the second shaft 133. The first polarity or the second polarity may be applied to the first impeller 15a coupled to the third shaft 135 through the motor 11 and the third shaft 135. The first polarity or the second polarity may be applied to the second impeller 15b coupled to the fourth shaft 137 through the motor 11 and the fourth shaft 137.

To be more specific, a plurality of first impellers 15a may be disposed on the shaft 13 to be spaced apart from each other, and a plurality of second impellers 15b may be disposed between the plurality of first impellers 15a. That is, the first impellers 15a and the second impellers 15b may be alternately arranged in a longitudinal direction of the shaft 13. Thus, the first impellers 15a and the second impellers 15b may more efficiently heat liquid and more effectively control a heat circulation degree, depending on the applied polarity.

The first impeller 15a rotates independently from the second impeller 15b. When the first impeller 15a rotates in a first direction, the second impeller 15b may be provided to rotate in the first direction or a second direction different from the first direction or to be stopped. The first direction may be clockwise, and the second direction may be counterclockwise. Further, the first direction may be counterclockwise, and the second direction may be clockwise.

To be more specific, when the first impeller 15a rotates in the first direction, the second impeller 15b may rotate in the first direction. Further, when the first impeller 15a rotates in the first direction, the second impeller 15b may rotate in the second direction. Furthermore, when the first impeller 15a rotates in the first direction, the second impeller 15b may stop rotating.

Further, when the second impeller 15b rotates in the first direction, the first impeller 15a may rotate in the first direction. Moreover, when the second impeller 15b rotates in the first direction, the first impeller 15a may rotate in the second direction. Furthermore, when the second impeller 15b rotates in the first direction, the first impeller 15a may stop rotating.

That is, the rotating directions of the first impeller 15a and the second impeller 15b may be variously set in consideration of the amount of flowing liquid, the speed of supplied liquid, the rotating speed of the first impeller 15a, and the rotating speed of the second impeller 15b. Thus, the heating level and circulation speed of the liquid flowing inside the housing 3 may be precisely controlled.

Meanwhile, the housing 3 may include a housing body 31, a housing rear part 32, and a housing front part 33. The housing body 31 may be provided to surround the power unit 1. That is, the housing body 31 may be provided in a hollow cylindrical shape, so that the power unit 1 may be disposed therein and liquid may flow therein.

The housing rear part 32 may be positioned at the rear of the housing body 31 to make the inside and outside of the housing body 31 communicate with each other, allowing liquid to be introduced. To be more specific, the housing rear part 32 may include a housing rear body 321, a housing rear through hole 322, and a housing rear extension 323.

The housing rear body 321 may be coupled to the rear of the housing body 31 to close the rear of the housing body 31. The housing rear through hole 322 may be formed through the center of the housing rear body 321 to allow liquid to flow into the housing body 31.

The housing rear extension 323 may extend rearward while surrounding the housing rear through hole 322. That is, the housing rear extension 323 may guide liquid to stably flow into the housing body 31.

The housing front part 33 may be positioned at the front of the housing body 31 to make the inside and outside of the housing body 31 communicate with each other, allowing liquid introduced into the housing rear part 32 to pass through the power unit 1 and then be discharged to the outside. To be more specific, the housing front part 33 may include a housing front body 331, a housing front through hole 332, and a housing front extension 333.

The housing front body 331 may be coupled to the front of the housing body 31 to close the front of the housing body 31. The housing front through hole 332 may be formed through the center of the housing front body 331 to allow liquid flowing into the housing body 31 to be heated by the power unit 1 and be discharged to the outside by the rotational force of the power unit 1.

The housing front extension 333 may extend forward while surrounding the housing front through hole 332. That is, the housing front extension 333 may guide liquid to stably discharge the liquid from the inside of the housing body 31 to the outside.

Further, the housing 3 may include an outer housing 3a and an inner housing 3b. The inner housing 3b may be disposed to face the power unit 1, and the outer housing 3a may have a shape corresponding to that of the inner housing 3b to be spaced apart therefrom.

The outer housing 3a and the inner housing 3b are provided in a double structure to stably protect the power unit 1, stably heat liquid flowing therein, minimize external influences, and maximize heating efficiency. Each of the outer housing 3a and the inner housing 3b may include a housing body 31, a housing rear part 32, and a housing front part 33.

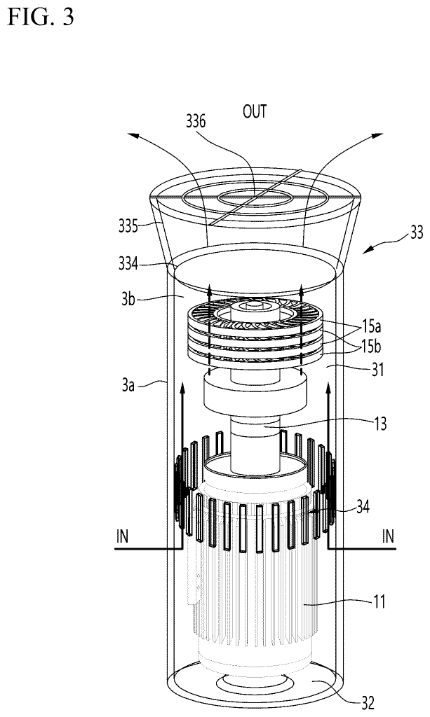

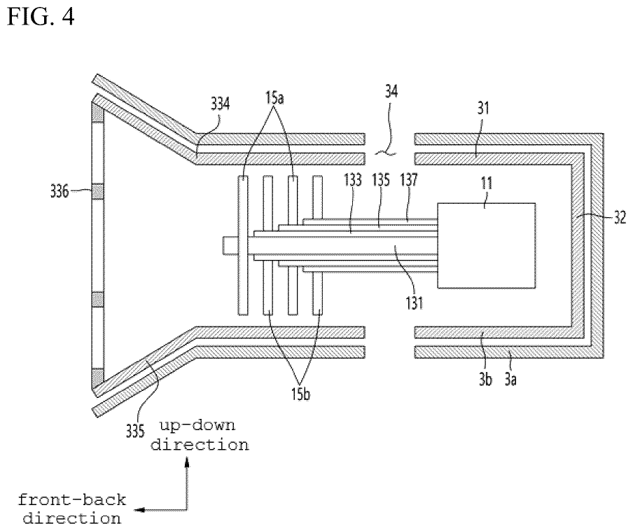

FIG. 3 is a perspective view of a heat pump according to an embodiment of the present disclosure. FIG. 4 is a sectional view of the heat pump illustrated in FIG. 3. Hereinafter, in explaining various embodiments of the present disclosure with reference to FIGS. 3 to 20, a duplicated description will be omitted and a description will be focused on changed or added components.

Referring to FIGS. 3 and 4, the housing 3 according to an embodiment of the present disclosure may include a housing body 31, a housing inlet 34, a housing front part 33, and a housing rear part 32.

The housing body 31 may be provided to surround the power unit 1. A plurality of housing inlets 34 may be formed along the periphery of the housing body 31 to be spaced apart from each other, and may make the inside and outside of the housing body 31 communicate with each other, thereby allowing liquid to be introduced.

That is, the housing inlet 34 may be disposed in the center of the housing body 31 so that liquid may be introduced from the side of the housing 3, thereby minimizing the flow resistance of the liquid when the liquid is introduced to face the housing body 31, and allowing the liquid to be easily heated and discharged.

The housing front part 33 may be disposed at the front of the housing body 31 to make the inside and outside of the housing body 31 communicate with each other, thereby allowing liquid introduced into the housing inlet 34 to pass through the power unit 1 and then flow out to the outside.

To be more specific, the housing front part 33 may include a housing front coupler 334, a housing front extender 335, and a housing front adjuster 336. The housing front coupler 334 may be coupled to the housing body 31.

The housing front extender 335 may extend from the housing front coupler 334 to be inclined in a direction away from the housing body 31 and thereby increase a cross-sectional area thereof. That is, the housing front extender 335 may discharge liquid heated by the power unit 1 at a reduced speed and in a larger flow rate, thereby improving safety. The housing front adjuster 336 may be provided in front of the housing front extender 335 to adjust the flow rate of liquid flowing out to the outside. The housing rear part 32 may be disposed at the rear of the housing body 31 to close the housing body 31.

Further, the housing 3 may include an outer housing 3a and an inner housing 3b. The inner housing 3b may be disposed to face the power unit 1, and the outer housing 3a may have a shape corresponding to that of the inner housing 3b to be spaced apart therefrom.

The outer housing 3a and the inner housing 3b are provided in a double structure to stably protect the power unit 1, stably heat liquid flowing therein, minimize external influences, and maximize heating efficiency. Each of the outer housing 3a and the inner housing 3b may include a housing body 31, housing inlets 34, a housing front part 33, and a housing rear part 32.

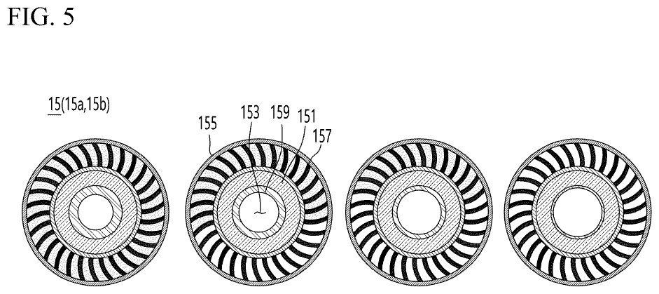

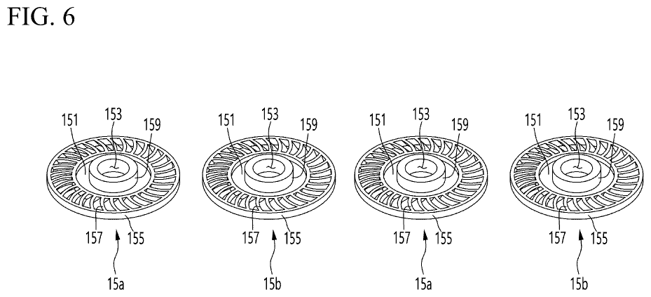

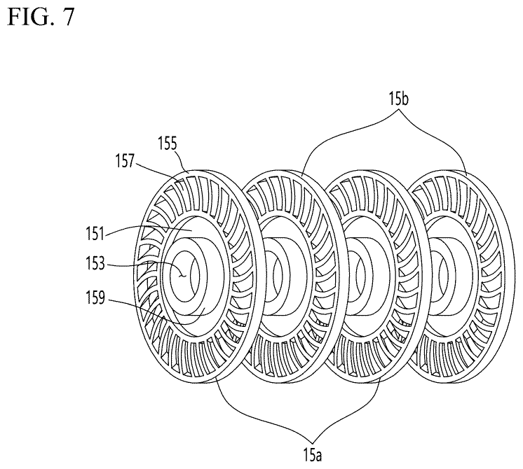

FIG. 5 is a front view of rotary bodies according to an embodiment of the present disclosure. FIG. 6 is a diagram illustrating the arrangement of rotary bodies according to an embodiment of the present disclosure. FIG. 7 is a diagram illustrating a state for coupling the rotary bodies according to an embodiment of the present disclosure to a shaft.

Referring to FIGS. 5 to 7, the rotary body 15 according to an embodiment of the present disclosure may include a rotary body part 151, a rotary penetration part 153, a rotary outer part 155, and a rotary blade 157. The rotary body part 151 may define an external appearance.

The rotary penetration part 153 may be formed through the center of the rotary body part 151 to be fitted over the shaft 13. Further, the shaft 13 may be placed inside the rotary penetration part 153. Further, the rotary penetration part 153 may be provided to correspond to the diameter of the shaft 13 due to the multi-stage structure of the plurality of shafts 13. The expression “correspond” may mean “identical”.

The rotary outer part 155 may be spaced apart from the rotary body part 151, and may be provided to surround the rotary body part 151. A plurality of rotary blades 157 may be provided between the rotary body part 151 and the rotary outer part 155, and may connect the rotary body part 151 and the rotary outer part 155. That is, the rotary blade 157 may rotate to promote the flow of liquid. In other words, the liquid placed between the power unit 1 and the housing 3 may be heated due to a difference in polarity, and the heated liquid may be discharged to the outside by the rotation of the rotary blade 157.

Further, at least some rotary blades 157 may be closed. That is, the rotary blades 157 may maximize a heating area by completely closing space between the plurality of rotary blades 157. Further, the rotary blades 157 may maximize liquid circulation by completely opening space between the plurality of rotary blades 157. In other words, the open area of the rotary blades 157 may be set in consideration of the type of liquid, the number of rotary blades 157, and the set temperature of the liquid, so that heating can be efficiently performed and circulation efficiency can be improved. Further, each of the first impeller 15a and the second impeller 15b may include a rotary body part 151, a rotary penetration part 153, a rotary outer part 155, and a rotary blade 157.

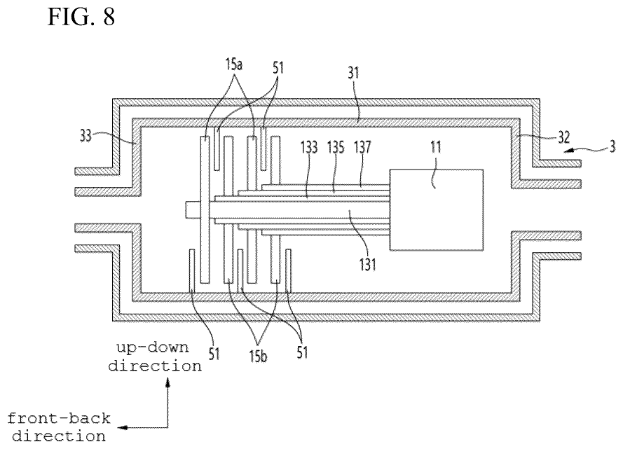

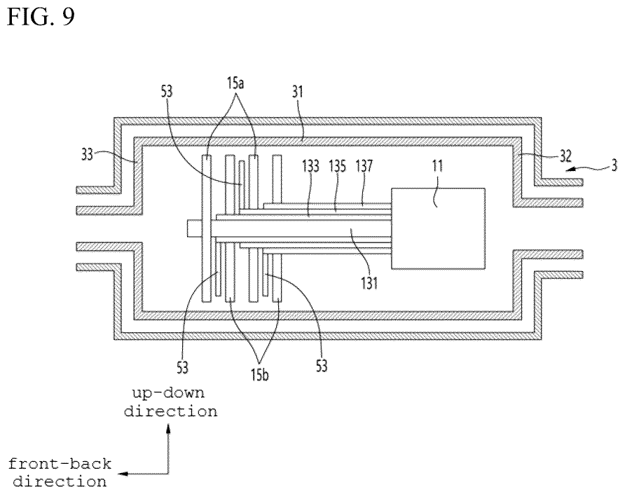

FIG. 8 is a diagram illustrating a heat pump including a housing partition wall according to an embodiment of the present disclosure. FIG. 9 is a diagram illustrating a heat pump including a shaft partition wall according to an embodiment of the present disclosure.

Referring to FIGS. 8 and 9, a heat pump S according to an embodiment of the present disclosure may include a partition wall 5. The partition wall 5 may be provided on the housing 3 or the shaft 13 to control the flow amount and flow speed of liquid flowing inside the housing 3.

To be more specific, the partition wall 5 may include a housing partition wall 51 and a shaft partition wall 53. A plurality of housing partition walls 51 may protrude from the inner surface of the housing 3 to control the flow amount of liquid flowing inside the housing 3.

Further, the housing partition walls 51 may protrude from the inner surface of the housing 3 to be disposed between the plurality of rotary bodies 15. That is, the housing partition walls 51 may protrude from the inner surface of the housing 3 to be disposed between the first impeller 15a and the second impeller 15b.

The housing partition walls 51 may be applied with a first polarity or a second polarity, and all of the plurality of rotary bodies 15 may be applied with a polarity different from that of the housing partition walls 51. That is, the housing partition walls 51 may be applied with the first polarity or the second polarity, and all of the first impellers 15a and the second impellers 15b may be applied with a polarity different from that of the housing partition walls 51 to heat liquid due to a difference in polarity.

Further, the housing partition walls 51 may protrude so that ends thereof face the first and second impellers 15a and 15b, thereby delaying the flow of liquid inside the housing 3 and maximizing the heating of the liquid.

A plurality of shaft partition walls 53 may protrude from the shaft 13 to control the amount of liquid flowing inside the housing 3. Further, the shaft partition walls 53 may protrude from the outer surface of the shaft 13 to be disposed between the plurality of rotary bodies 15. That is, the shaft partition walls 53 may protrude from the outer surface of the shaft 13 to be disposed between the first and second impellers 15a and 15b.

Further, the shaft partition walls 53 may be applied with a first polarity or a second polarity, and all of the plurality of rotary bodies 15 may be applied with a polarity different from that of the shaft partition walls 53. That is, the shaft partition walls 53 may be applied with the first polarity or the second polarity, and all of the first impellers 15a and the second impellers 15b may be applied with a polarity different from that of the shaft partition walls 53 to heat liquid due to a difference in polarity.

Further, the shaft partition wall 53 may be provided with a protrusion height smaller than the height of the first impeller 15a and the height of the second impeller 15b. Thus, the shaft partition wall 53 may rotate together with the shaft 13 to increase the flow speed of liquid, thereby improving heat circulation efficiency. The housing partition wall 51 and the shaft partition wall 53 may be provided separately or together.

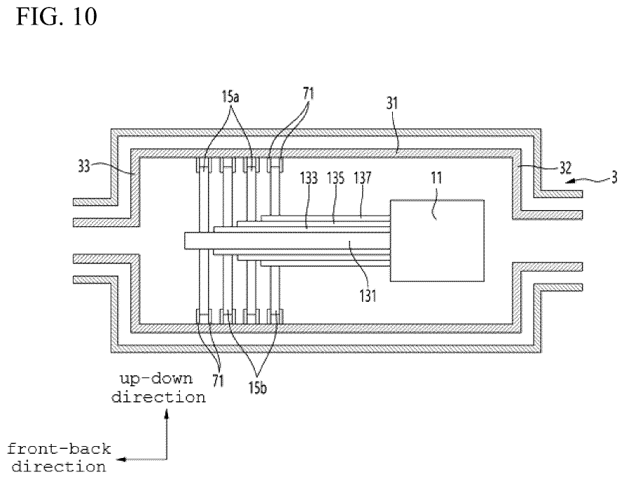

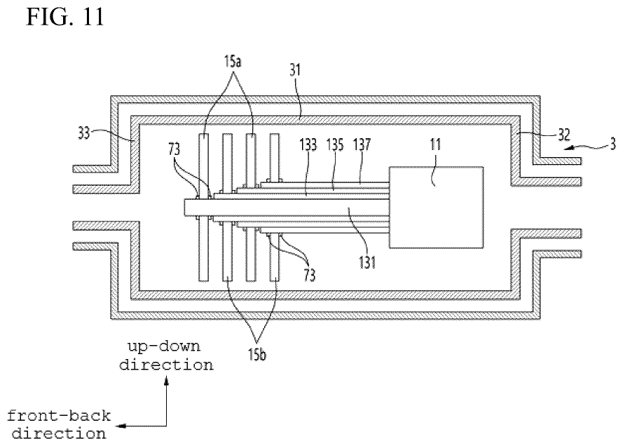

FIG. 10 is a diagram illustrating a heat pump including a housing slot according to an embodiment of the present disclosure. FIG. 11 is a diagram illustrating a heat pump including a shaft slot according to an embodiment of the present disclosure.

Referring to FIGS. 10 and 11, a heat pump S according to an embodiment of the present disclosure may include a slot part 7. The slot part 7 may be provided on the housing 3 or the shaft 13 so that the rotary body 15 may be detachably attached.

The slot part 7 may include a housing slot 71 and a shaft slot 73. The housing slot 71 may be provided on the inner surface of the housing 3 so that a plurality of rotary bodies 15 may be detachably attached.

Further, the housing slot 71 may be provided to surround an outer end of the rotary body 15. That is, the outer end of the rotary body 15 may be inserted into and coupled to the housing slot 71, so that the number of rotary bodies 15 coupled to the shaft 13 can be conveniently adjusted. Furthermore, the housing slot 71 may be spaced apart from the outer end of the rotary body 15 by a predetermined distance or may contact the outer end so that rotation is not impeded, thereby allowing rotation to be easily performed.

The shaft slot 73 may be provided on the outer surface of the shaft 13 so that a plurality of rotary bodies 15 may be detachably attached. Further, the shaft slot 73 may be provided to surround the center of the rotary body 15. That is, the center of the rotary body 15 may be inserted into and coupled to the shaft slot 73, so that the number of rotary bodies 15 coupled to the shaft 13 may be conveniently adjusted. Further, the shaft slot 73 may be spaced apart from the center of the rotary body 15 by a predetermined distance or may contact the rotary body so that rotation is not impeded, thereby allowing rotation to be easily performed.

The housing slot 71 and the shaft slot 73 may be provided separately or together to fix the rotary body 15. Thus, the heating degree of liquid can be conveniently adjusted and the circulation speed of the liquid can be conveniently adjusted.

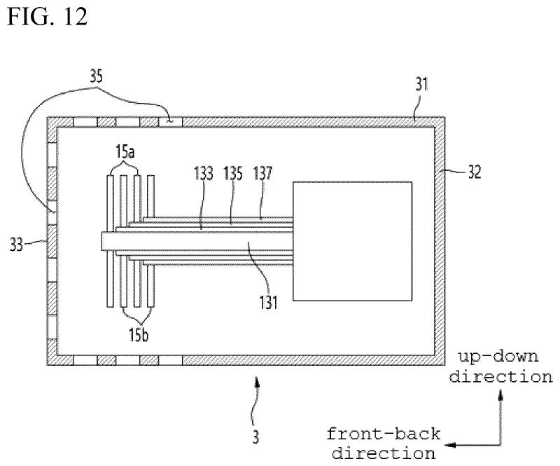

FIG. 12 is a sectional view of a heat pump according to an embodiment of the present disclosure. Referring to FIG. 12, the housing 3 according to an embodiment of the present disclosure may include a housing body 31, a housing front part 33, a housing rear part 32, and a housing through hole 35.

The housing body 31 may be provided to surround the power unit 1, the housing front part 33 may be disposed at the front of the housing body 31, and the housing rear part 32 may be disposed at the rear of the housing body 31.

A plurality of housing through holes 35 may be formed through the housing body 31 and the housing front part 33 to allow liquid to flow into and out of the housing body 31. That is, the housing body 31, the housing front part 33, and the housing rear part 32 may form a cylindrical shape, and a plurality of housing through holes 35 may be formed in the periphery of the housing body 31 and the housing front part 33 to be spaced apart from each other, thereby minimizing the volume of the entire heat pump S. After liquid is easily introduced into the housing body 31 through the housing through holes 35 formed in the housing body 31 and is efficiently heated by the power unit 1, the liquid may be easily discharged to the outside through the housing through holes 35 formed in the housing front part 33.

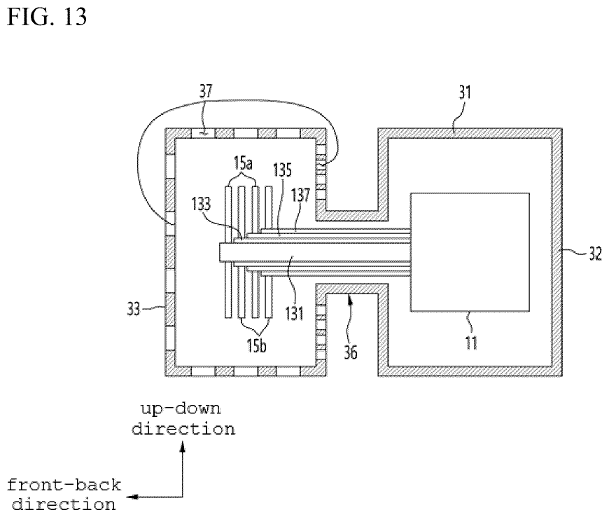

FIG. 13 is a diagram illustrating a heat pump including a housing recess according to an embodiment of the present disclosure. Referring to FIG. 13, a housing 3 according to an embodiment of the present disclosure may include a housing body 31, a housing recess 36, and a housing inlet hole 37.

The housing body 31 may be provided to surround the power unit 1. The housing recess 36 may be formed by recessing toward the shaft 13 on the outer surface of the housing body 31.

A plurality of housing inlet holes 37 may be formed through the housing body 31 and the housing recess 36 to allow liquid to flow into and out of the housing body 31. Further, the housing inlet holes 37 may be formed in a surface of the housing recess 36 facing the rotary body 15.

To be more specific, the housing recess 36 may be formed by recessing at least a portion of a side of the housing 3 facing the shaft 13. Further, the housing recess 36 may be supplied with power of a polarity opposite to that of the power unit 1 through the housing 3.

Thus, the heat generation of liquid may occur between the rotary body 15 and a surface of the housing recess 36 facing the rotary body 15 in a front-back direction. In addition, the heat generation of liquid may occur between the shaft 13 and a surface of the housing recess 36 facing the shaft 13 in a radial direction, thereby increasing the heat generation amount of the heat pump S.

As the position, length, width, shape, etc. of the housing recess 36 change, gaps and areas between the housing recess 36 and the rotary body 15 and the shaft 13 to which power of different polarities is applied change, so that the heat generation amount of the heat pump S may differ depending on the shape of the housing recess 36.

The housing inlet holes 37 may be formed in a surface of the housing recess 36 facing the rotary body 15 in the front-back direction. As the rotary body 15 rotates, liquid may flow into the housing 3 through the housing inlet holes 37 formed in the housing recess 36.

Further, the rotary body 15 and the housing recess 36 are supplied with power of opposite polarities, so that heat may be generated in the liquid between the rotary body 15 and the housing recess 36. Thus, the amount of liquid circulating inside and outside the housing 3 may be increased due to the inflow of liquid into and out of the housing 3 through the housing inlet holes 37 formed in the housing recess 36, an eddy generated by the flow of liquid inside and outside the housing 3, or convection generated by the heat generation of liquid inside the housing 3.

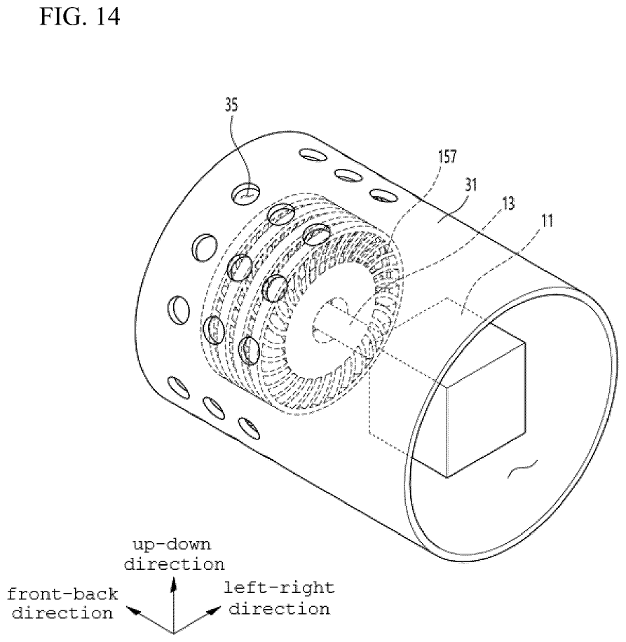

FIG. 14 is a perspective view illustrating a heat pump with a side of a housing being open, according to an embodiment of the present disclosure. Referring to FIG. 14, the housing 3 according to an embodiment of the present disclosure may include a housing body 31, and may optionally include either a housing front part 33 or a housing rear part 32.

That is, the housing body 31 may be provided to surround the power unit 1, the housing front part 33 may be disposed at the front of the housing body 31, and the housing rear part 32 may be disposed at the rear of the housing body 31. As only one of the housing front part 33 and the housing rear part 32 is provided, the housing 3 may have either of a surface facing the motor 11 in the front-back direction and a surface facing the rotary body 15 in the front-back direction open. Further, the housing 3 may be provided with both the housing front part 33 and the housing rear part 32, and each may be opened to a certain extent. Furthermore, the housing 3 may not have both the housing front part 33 and the housing rear part 32, so that both sides thereof may be open.

That is, as the opening degree of the housing 3 increases, the amount of liquid circulating in the housing 3 may increase. Therefore, the proper opening degree and shape of the housing 3 may be selected in consideration of a desired liquid circulation amount in the housing 3.

Further, the opening degree between a plurality of rotary blades 157 of the rotary body 15 may be set depending on a circumstance. At this time, the opening degree of each rotary blade 157 and the opening degree of the housing 3 may be set by taking into consideration of the opening degree of the housing 3.

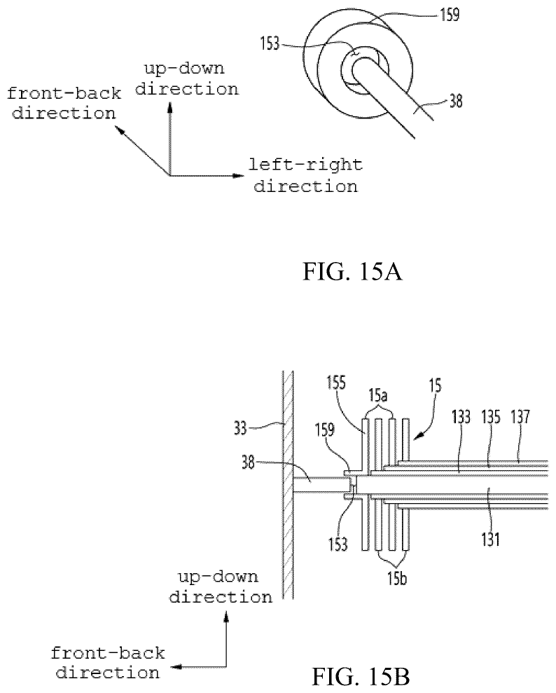

FIGS. 15A and 15B are diagrams illustrating a heat pump including a housing extension according to an embodiment of the present disclosure. Referring to FIGS. 15A and 15B, a rotary body 15 according to an embodiment of the present disclosure may include a rotary body part 151, a rotary penetration part 153, a rotary outer part 155, a rotary blade 157, and a rotary support part 159.

The rotary body part 151 may define an external appearance. The rotary penetration part 153 may be formed through the center of the rotary body part 151 to be fitted over the shaft 13. The rotary outer part 155 may be spaced apart from the rotary body part 151, and may be provided to surround the rotary body part 151. A plurality of rotary blades 157 may be provided between the rotary body part 151 and the rotary outer part 155, and may connect the rotary body part 151 and the rotary outer part 155. The rotary support part 159 may be provided to surround the rotary penetration part 153, and may protrude from the center of the rotary body part 151.

Further, the housing 3 may include a housing body 31, a housing front part 33, a housing rear part 32, and a housing extension 38. The housing body 31 may be provided to surround the power unit 1, the housing front part 33 may be disposed at the front of the housing body 31 to close the housing body 31 and be arranged such that an inner surface thereof faces the rotary support part 159, and the housing rear part 32 may be disposed at the rear of the housing body 31 to close the housing body 31.

The housing extension 38 may extend from the inner surface of the housing front part 33 toward the rotary penetration part 153 to be disposed inside the rotary support part 159. That is, the housing extension 38 may extend from the inner side of a surface facing the rotary support part 159 of the housing 3, may be applied with power through the housing 3, and may be inserted into the rotary support part 159.

To be more specific, the housing extension 38 may extend from the housing 3 to be supplied with power having the same polarity as the housing 3, and may be inserted to be spaced apart from the inner wall of the rotary support part 159 that receives power of a polarity opposite to that of the housing 3. Thus, when viewed in the radial direction of the rotary body 15, components having a polarity opposite to that of power applied in the order of the housing 3, the rotary body 15, and the housing extension 38 may be alternately arranged to increase the heat generation amount of the heat pump S.

Further, liquid positioned between the housing extension 38 and the inner wall of the rotary support part 159 may generate additional heat by applying power of opposite polarities to the housing extension 38 and the rotary support part 159. Therefore, due to additional heat generation of the liquid between the housing extension 38 and the inner wall of the rotary support part 159, convection of liquid located inside and outside the housing 3 occurs, so that the circulation amount of the liquid inside and outside the housing 3 may increase.

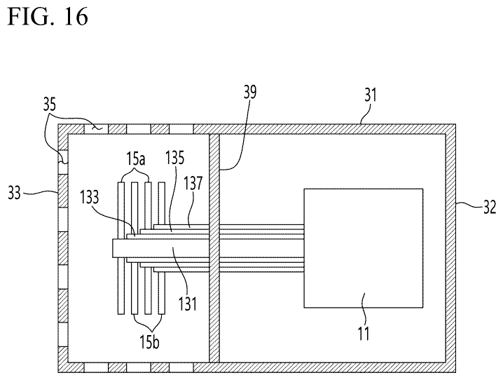

FIG. 16 is a diagram illustrating a heat pump including a housing waterproofing part according to an embodiment of the present disclosure. Referring to FIG. 16, the housing 3 according to an embodiment of the present disclosure may include a housing body 31, a housing front part 33, a housing rear part 32, and a housing waterproofing part 39.

The housing body 31 may be provided to surround the power unit 1, the housing front part 33 may be disposed at the front of the housing body 31 to close the housing body 31, and the housing rear part 32 may be disposed at the rear of the housing body 31 to close the housing body 31. Further, a plurality of housing through holes 35 may be formed through the housing body 31 and the housing front part 33 so that liquid may flow into and out of the housing 3.

The housing waterproofing part 39 may be disposed inside the housing body 31 to surround the shaft 13, thereby separating the motor 11 and the rotary body 15, and may be provided to seal the motor 11. As described above, when viewed in the front-back direction, the housing through hole 35 may not be formed in the area of the housing 3 in which the motor 11 is provided, based on the housing waterproofing part 39.

Thus, liquid may not flow into space of the housing 3 which is sealed by the housing waterproofing part 39 and into which the motor 11 is accommodated. Therefore, when configuring the heat pump S, a non-waterproof motor 11 may be used, and other components vulnerable to moisture may be disposed in the corresponding space, thereby improving design flexibility and reducing manufacturing cost.

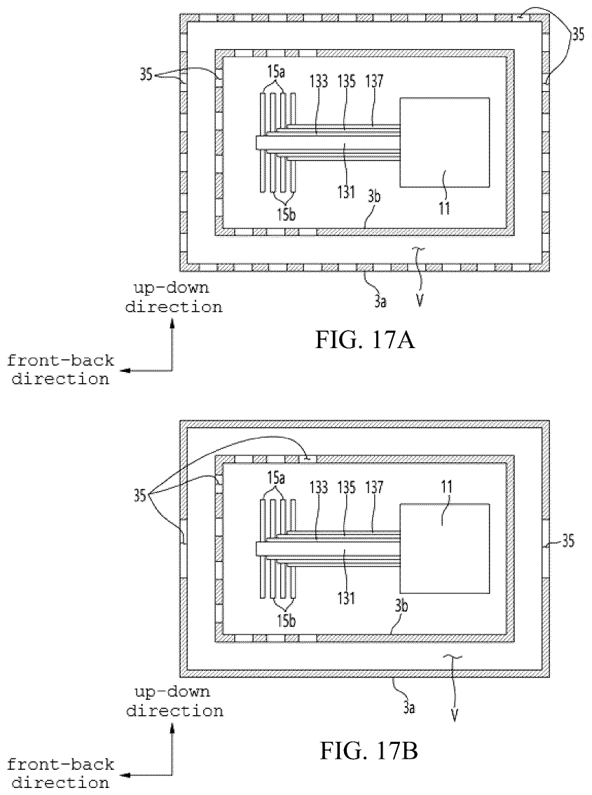

FIGS. 17A and 17B are diagrams illustrating a heat pump including a double housing structure according to an embodiment of the present disclosure. To be more specific, FIG. 17A shows that a plurality of through holes are formed in the outer housing 3a to be spaced apart from each other, and FIG. 17B shows that through holes are formed at the front and rear of the outer housing 3a, respectively.

Referring to FIGS. 17A and 17B, a housing 3 according to an embodiment of the present disclosure may include an outer housing 3a and an inner housing 3b. The inner housing 3b may be configured to accommodate the power unit 1 therein. The outer housing 3a may be configured to accommodate the inner housing 3b therein.

Further, a space V in which liquid may flow may be formed between the inner housing 3b and the outer housing 3a. At this time, the outer housing 3a may be configured so as not to receive power. Thus, the wear speed of the outer housing 3a may be reduced, and accidents such as electric shock or burns may be prevented from occurring when a user contacts the outer housing 3a.

FIG. 17A illustrates that a plurality of housing through holes 35 are formed in surfaces of the outer housing 3a facing the inner housing 3b in the front-back direction and the radial direction. That is, since liquid located in the space V may flow through the plurality of housing through holes 35 formed in the front-back direction and radial direction in the outer housing 3a, the amount of the liquid flowing inside and outside the outer housing 3a may increase.

FIG. 17B illustrates that the outer housing 3a has at least one housing through hole 35 in each of a pair of surfaces (front and rear surfaces) facing the inner housing 3b in the front-back direction. That is, liquid located in the space V is surrounded by the inner housing 3b and the outer housing 3a in directions other than the front-back direction, so that the flow of liquid into and out of the outer housing 3a may be concentrated in the front-back direction.

Thus, the flow of the liquid in the space V between the inner housing 3b and the outer housing 3a may have a relatively constant directionality in the limited space V. That is, by measuring the flow speed of the liquid, the temperature of the liquid, etc. in the space V, the performance of the heat pump S may be measured more easily.

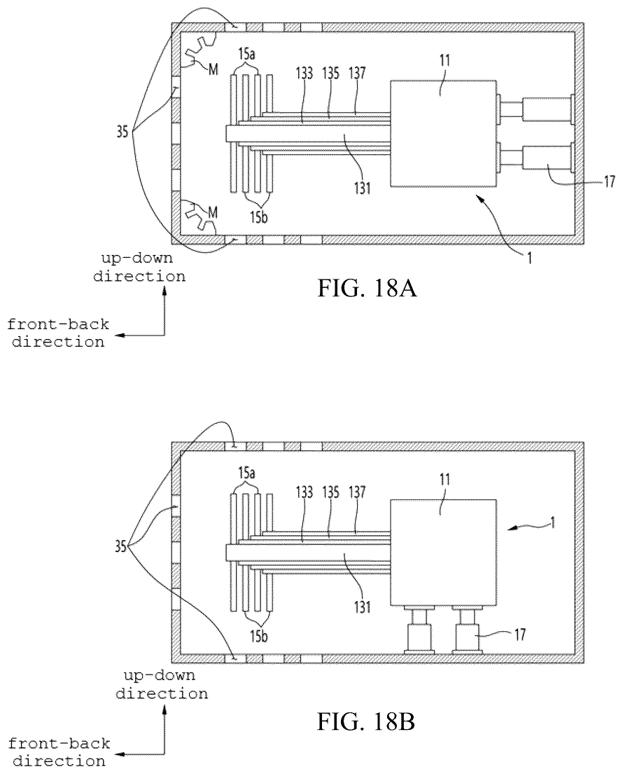

FIGS. 18A and 18B are diagrams illustrating a heat pump including a shock absorbing member or a linear driving part according to an embodiment of the present disclosure. FIG. 18A shows a heat pump including a linear driving part and a shock absorbing member, and FIG. 18B shows a heat pump including a linear driving part.

The power unit 1 according to an embodiment of the present disclosure may include a linear driving part 17. The linear driving part 17 may be provided in the housing 3 to move the motor 11, the shaft 13, and the rotary body 15 in at least one of the front-back direction and the radial direction.

To be more specific, the linear driving part 17 may be supported on a surface of the housing 3 facing the motor 11 in the front-back direction. At this time, the linear driving part 17 may be configured in the form of at least one linear actuator configured to move the motor 11 in the front-back direction. That is, one end of the linear driving part 17 may be coupled to a surface of the housing 3 facing the motor 11 in the front-back direction, while the other end of the linear driving part 17 may be coupled to the motor 11.

By moving the power unit 1 through the driving of the linear driving part 17, a gap between the housing 3 and the power unit 1 may be adjusted to control the heat generation amount of the heat pump S. Thus, even if the installation location and installation angle of the heat pump S are changed in a place where the heat pump S is installed, the heat generation amount of the heat pump S may be increased by moving the power unit 1 through the driving of the linear driving part 17 to form an optimal gap between the housing 3 and the power unit 1 considering the changed installation location of the heat pump S.

Since the movement of the power unit 1 through the driving of the linear driving part 17 generates the flow of liquid inside and outside the housing 3, it can improve the circulation of liquid inside and outside the housing 3. Thus, when the generation of rotational driving force through the rotary body 15 of the power unit 1 is limited, liquid may flow into and out of the housing 3 by linearly moving the power unit 1 in the front-back direction using the linear driving part 17, thereby minimizing the deterioration of the heat pump S.

Meanwhile, the linear driving part 17 may be supported on a surface of the housing 3 facing the motor 11 in a radial direction. At this time, the linear driving part 17 may be configured in the form of at least one linear actuator configured to move the motor 11 in the radial direction of the housing 3. That is, one end of the linear driving part 17 may be coupled to a surface of the housing 3 facing the motor 11 in the radial direction of the housing 3, and the other end of the linear driving part 17 may be coupled to the motor 11.

Since the movement of the power unit 1 through the driving of the linear driving part 17 generates the flow of liquid inside and outside the housing 3, it can improve the circulation of liquid inside and outside the housing 3.

Further, the heat pump S according to an embodiment of the present disclosure may include a shock absorbing member M. The shock absorbing member M is provided in the housing 3 to absorb shock. That is, the shock absorbing member M may be provided at the corner of a surface of the housing 3 facing the rotary body 15 in the front-back direction.

Further, the shock absorbing member M may prevent the rotary body 15, the shaft 13, and the motor 11 from colliding with the housing 3 due to a movement caused by the rotational driving force or vibration of the power unit 1, a linear movement caused by the driving of the linear driving part 17, etc.

The shock absorbing member M may be formed of an elastic material such as rubber, and may be provided in a shape in which multiple polyhedrons protrude as shown in FIG. 18A, but is not limited thereto.

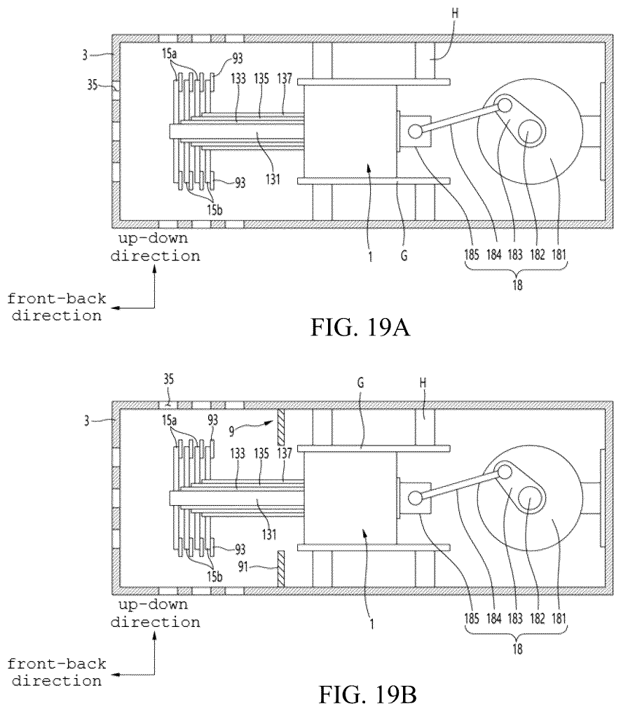

FIGS. 19A and 19B are diagrams illustrating a heat pump including an insulating part and a crank part according to an embodiment of the present disclosure. To be more specific, FIG. 19A shows a crank part and a rotary insulating part, and FIG. 19B shows a crank part and a housing insulating part.

Referring to FIGS. 19A and 19B, the heat pump S according to an embodiment of the present disclosure may include a guide member G and a support member H, and the power unit 1 may include a crank part 18.

The guide member G may be configured to suppress the movement of the motor 11 in the radial direction of the housing 3 and guide the movement of the motor 11 in the front-back direction. To be more specific, the guide member G has a length in the front-back direction corresponding to the moving range of the motor 11 in the front-back direction as the crank part 18 is driven. The guide member may be configured such that at least a portion thereof contacts the motor 11 in the radial direction to suppress the movement of the motor 11 in the radial direction and guide the movement of the motor 11 in the front-back direction.

The support member H may be configured to support the guide member G in the radial direction of the housing 3. To be more specific, one end of the support member H may be coupled to a surface of the housing 3 facing the guide member G in the radial direction, while the other end may be coupled to the guide member G.

The crank part 18 may be supported on the inner surface of the housing 3 to move the power unit 1 in the front-back direction. To be more specific, the crank part 18 may include a flywheel 181, a crank shaft 182, a crank arm 183, a connecting rod 184, and a connecting member 185.

The flywheel 181 may store rotational energy resulting from the driving of the crank part 18, thereby preventing sudden speed fluctuations in the crank part 18. The crank shaft 182 may be formed along an axis orthogonal to the front-back direction, and may be connected to a separate servo motor (not shown) to receive power and then rotate. The crank arm 183 may be connected to the crank shaft 182 to be rotated.

One end of the connecting rod 184 may be connected to the crank arm 183, and the other end may be coupled to the connecting member 185. That is, the connecting rod 184 may be rotatably connected to the crank arm 183, and may transmit power generated by the rotation of the crank arm 183 to the connecting member 185.

One end of the connecting member 185 may be connected to the connecting rod 184, while the other end may be coupled to the motor 11. At this time, the connecting member 185 may move the motor 11 in the front-back direction as the crank arm 183 rotates.

That is, the crank part 18 may move the power unit 1 in the front-back direction to adjust a gap between the housing 3 and the power unit 1, thereby controlling the heat generation amount of the heat pump S.

Further, since the movement of the power unit 1 through the driving of the crank part 18 generates a flow of liquid into and out of the housing 3, it can improve the circulation of liquid in and out of the housing 3.

Meanwhile, an insulating part 9 may be provided in the housing 3 or the rotary body 15 to suppress the flow of current. The insulating part 9 may include a housing insulating part 91 and a rotary insulating part 93. The rotary insulating part 93 may be formed of an insulator that is provided on the rotary body 15 to suppress the flow of current.

Further, the rotary insulating part 93 may be configured in the shape of a disc with a groove formed in the center to be spaced apart from the shaft 13 by a predetermined distance in the radial direction of the shaft 13 and from the housing 3 by a predetermined distance in the radial direction of the housing 3.

That is, the rotary insulating part 93 may be configured such that at least a portion thereof is coupled to a surface of the rotary body 15 facing the motor 11. Therefore, when viewed from the front-back direction, the heated liquid between the housing 3 and the rotary body 15 to which power of different polarities is applied may be circulated mostly in the area of the housing 3 equipped with the rotary body 15 with respect to the rotary insulating part 93, and the outside of the housing 3 adjacent thereto.

That is, when viewed from the front-back direction, the heat generation of the heat pump S and the circulation of liquid in and out of the housing 3 may occur mostly in the area of the housing 3 equipped with the rotary body 15 with respect to the rotary insulating part 93, and the outside of the housing 3 adjacent thereto.

Further, when viewed from the front-back direction, the motor 11, the shaft 13, and the crank part 18 located in the area of the housing 3 equipped with the motor 11 with respect to the rotary insulating part 93, may be reduced in wear speed due to the liquid heated inside the housing 3.

Further, when the power unit 1 is moved by driving the crank part 18, a flow of liquid into and out of the housing 3 may occur due to the movement of the rotary insulating part 93 coupled to the rotary body 15. Therefore, the rotary insulating part 93 can improve the circulation of liquid in and out of the housing 3.

The housing insulating part 91 may be provided in the housing 3, and may be formed of an insulator to suppress the flow of current.

Further, the housing insulating part 91 may be spaced apart from the shaft 13 by a predetermined distance in the radial direction of the shaft 13, and may be coupled to a surface of the housing 3 that faces the shaft 13 in the radial direction.

That is, when viewed from the front-back direction, the housing insulating part 91 may be positioned in the area of the housing 3 in a direction where the motor 11 is installed with respect to the rotary body 15 so that an end thereof does not interfere with the moving range of the rotary body 15 in the front-back direction due to the driving of the crank part 18.

Therefore, when viewed from the front-back direction, the heated liquid between the housing 3 and the rotary body 15 to which power of different polarities is applied may be circulated mostly in the area of the housing 3 equipped with the rotary body 15 with respect to the housing insulating part 91, and the outside of the housing 3 adjacent thereto.

That is, when viewed from the front-back direction, the heat generation of the heat pump S and the circulation of liquid in and out of the housing 3 may occur mostly in the area of the housing 3 equipped with the rotary body 15 with respect to the housing insulating part 91, and the outside of the housing 3 adjacent thereto. Further, when viewed from the front-back direction, the motor 11, the shaft 13, and the crank part 18 located in the area of the housing 3 equipped with the motor 11 with respect to the housing insulating part 91 may be reduced in wear speed due to the heated liquid.

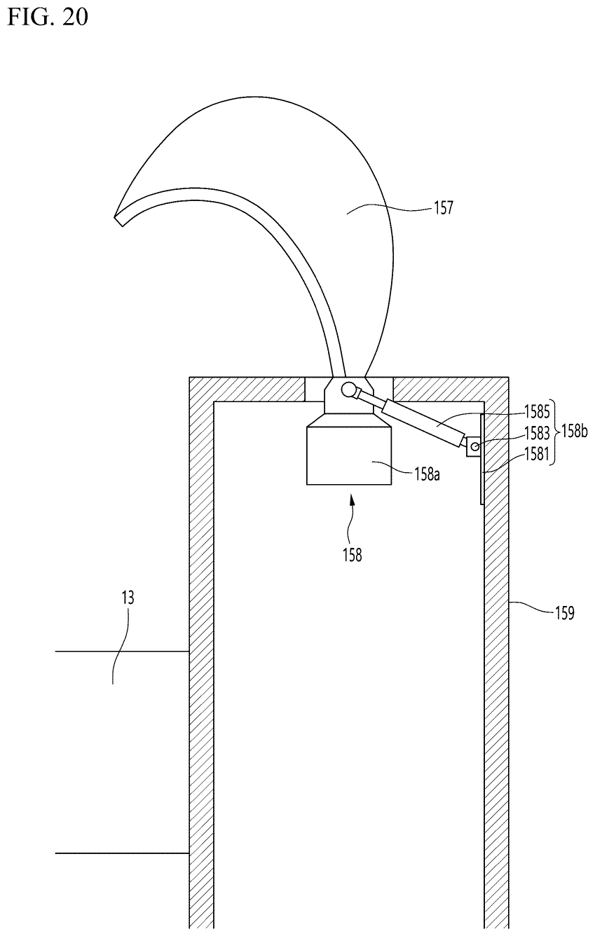

FIG. 20 is a diagram illustrating a heat pump including a blade control part according to an embodiment of the present disclosure. A rotary body 15 according to an embodiment of the present disclosure may include a blade control part 158.

The blade control part 158 may be provided in the rotary support part 159 to adjust the angle and location of the rotary blade 157. Further, when the blade control part 158 is provided, the rotary outer part 155 may be eliminated.

Further, the blade control part 158 may be configured to control at least one of the rotation angle of the rotary blade 157 with respect to the radial direction of the rotary support part 159 and the rotation angle of the rotary blade 157 with respect to a side of the rotary support part 159 facing the inner surface of the housing 3 in the radial direction of the rotary support part 159.

To be more specific, the blade control part 158 may include a first blade control part 158a and a second blade control part 158b. The first blade control part 158a may be configured in the form of a motor to rotate the rotary blade 157 in the radial direction of the rotary support part 159. Thus, the rotary blade 157 may rotate in the same direction as the motor rotating direction of the first blade control part 158a.

That is, the blade control part 158 may control the rotation angle of the rotary blade 157 with respect to the radial direction of the rotary support part 159 by adjusting the motor rotation of the first blade control part 158a. The second blade control part 158b may include a guide rail 1581, a rail coupling member 1583, and a linear driving device 1585.

The first blade control part 158a may be rotatably coupled to the rotary support part 159 to be rotatable about the side of the rotary support part 159 facing the inner surface of the housing 3 in the radial direction of the rotary support part 159.

That is, when an external force is applied to the first blade control part 158a by the second blade control part 158b, the first blade control part 158a may rotate with respect to the side of the rotary support part 159 facing the inner surface of the housing 3 in the radial direction of the rotary support part 159 while being coupled to the rotary support part 159.

The guide rail 1581 may be coupled to the inner surface of the rotary support part 159 along the radial direction of the rotary support part 159. The rail coupling member 1583 may be configured such that one end thereof is coupled to the linear driving device 1585 and the other end is coupled to the guide rail 1581 to move along the guide rail 1581.

The linear driving device 1585 is configured in the form of a linear actuator, and may be formed to enable linear movement through extension and retraction. Further, one end of the linear driving device 1585 may be coupled to the first blade control part 158a, and the other end may be coupled to the rail coupling member 1583. Such a linear driving device 1585 may be driven by a separate servo motor (not shown).

That is, when the linear driving device 1585 is extended, the rail coupling member 1583 may move along the guide rail 1581 in the radial direction of the rotary support part 159. Further, as the rail coupling member 1583 moves, the linear driving device 1585 may rotate about the side of the rotary support part 159 facing the inner surface of the housing 3 in the radial direction of the rotary support part 159. Further, as the linear driving device 1585 rotates, the first blade control part 158a coupled to the linear driving device 1585 and the rotary blade 157 coupled to the first blade control part 158a may rotate.

Alternatively, when the linear driving device 1585 is retracted, the rail coupling member 1583 may move along the guide rail 1581 in the opposite direction when the linear driving device 1585 is extended. Further, the rotary blade 157 may rotate in the opposite direction when the linear driving device 1585 is extended.

That is, the blade control part 158 may adjust the rotation angle of the rotary blade 157 with respect to the side of the rotary support part 159 facing the inner surface of the housing 3 in the radial direction of the rotary support part 159 by extending or retracting the linear driving device 1585.

Further, the rotary blade 157 may be configured in a curved shape with respect to the radial direction of the rotary support part 159. Thus, when the rotation angle of the rotary blade 157 changes, the amount and direction of liquid pushed by the rotary body 15 included in the heat pump S may be changed.

Further, power of opposite polarities may be applied to the rotary blade 157 and the housing 3. Thus, the heat generation amount of the heat pump S may be changed depending on a gap and a facing area between the rotary blade 157 and the housing 3. At this time, the rotary blade 157 may be configured in a curved shape with respect to the radial direction of the rotary support part 159. Since the radial direction of the rotary support part 159 is the same as the radial direction of the housing 3, the gap and the facing area between the rotary blade 157 and the housing 3 may be changed if the rotation angle of the rotary blade 157 changes.

Thus, by controlling the rotation angle of the rotary blade 157 through the blade control part 158, the heat generation amount, the liquid flow amount, and the liquid flow direction of the heat pump S may be controlled.

Embodiments of the present disclosure are to provide a heat pump, which includes a plurality of rotary bodies, thereby improving heating performance and energy efficiency.

Further, embodiments of the present disclosure are to provide a heat pump, in which the power of a first polarity is supplied to some of a plurality of rotary bodies and the power of a second polarity is supplied to the remaining rotary bodies to rotate the rotary bodies in opposing directions or selectively rotate the rotary bodies, thereby improving heating performance and energy efficiency.

Further, embodiments of the present disclosure are to provide a heat pump having improved heating performance and improved energy efficiency, through an optimal inlet structure into which housing liquid is introduced.

Further, embodiments of the present disclosure are to provide a heat pump, which opens a portion of a rotary body, thereby securing heating performance, allowing liquid to easily flow, and improving energy efficiency.

From the above description, it will be understood by those skilled in the art to which the present disclosure belongs that the present disclosure may be changed in various ways without departing from the scope of the present disclosure. Therefore, the scope of the present disclosure should not be limited to the above-described embodiments, and is to be determined solely by the following claims or equivalence thereof.

What is claimed is:

1. A heat pump with improved energy efficiency, the heat pump comprising:
a power unit providing a rotational driving force for liquid circulation, and receiving power to heat liquid; and
a housing defining a space therein to allow the power unit to be disposed therein,
wherein the power unit comprises:
a motor;
a shaft connected to the motor to receive power; and
a plurality of rotary bodies rotatably provided on the shaft to be spaced apart from each other, and
wherein a first polarity or a second polarity different from the first polarity is applied to each of the plurality of rotary bodies.

2. The heat pump of claim 1, wherein each of the rotary bodies comprises:
a first impeller coupled to the shaft, the first polarity being applied thereto; and
a second impeller disposed on the shaft to be spaced apart from the first impeller, the second polarity being applied thereto.

3. The heat pump of claim 2, wherein:
a plurality of first impellers are arranged to be spaced apart from each other, and
a plurality of second impellers are arranged between the plurality of first impellers.

4. The heat pump of claim 3, wherein:
the first impeller rotates independently from the second impeller, and
the second impeller rotates in a first direction or a second direction different from the first direction or stops, when the first impeller rotates in the first direction.

5. The heat pump of claim 1, wherein the housing comprises:
a housing body provided to surround the power unit;
a housing rear part positioned at a rear of the housing body to make the inside and outside of the housing body communicate with each other, allowing liquid to be introduced therein; and
a housing front part positioned at a front of the housing body to make the inside and outside of the housing body communicate with each other, allowing the liquid introduced into the housing rear part to pass through the power unit and then be discharged to the outside.

6. The heat pump claim 1, wherein the housing comprises:
a housing body provided to surround the power unit;
a plurality of housing inlets formed through along a periphery of the housing body to be spaced apart from each other, and making the inside and outside of the housing body communicate with each other, thereby allowing liquid to be introduced; and
a housing front part disposed at a front of the housing body to make the inside and outside of the housing body communicate with each other, thereby allowing the liquid introduced into the housing inlets to pass through the power unit and then flow out to the outside.

7. The heat pump of claim 1, wherein:
each of the rotary bodies comprises:
a rotary body part defining an external appearance;
a rotary penetration part formed through a center of the rotary body part to be fitted over the shaft;
a rotary outer part spaced apart from the rotary body part, and provided to surround the rotary body part; and
a plurality of rotary blades provided between the rotary body part and the rotary outer part, and connecting the rotary body part and the rotary outer part, and
at least a portion of the rotary blades is closed.

8. The heat pump of claim 1, further comprising:
a plurality of housing partition walls protruding from an inner surface of the housing to control a flow amount of liquid flowing inside the housing;
wherein:
the housing partition walls protrude from the inner surface of the housing to be disposed between the plurality of rotary bodies, and
the first polarity or the second polarity is applied to the housing partition walls, and a polarity different from that of the housing partition walls is applied to all of the plurality of rotary bodies.

9. The heat pump of claim 1, further comprising:
a plurality of shaft partition walls protruding from the shaft to control a flow amount of the liquid flowing inside the housing,
wherein:
the shaft partition walls protrude from an outer surface of the shaft to be disposed between the plurality of rotary bodies, and
the first polarity or the second polarity is applied to the shaft partition walls, and a polarity different from that of the shaft partition walls is applied to all of the plurality of rotary bodies.

10. The heat pump of claim 1, further comprising:
a housing slot provided on the inner surface of the housing to allow the plurality of rotary bodies to be detachably attached thereto,
wherein the housing slot is provided to surround an outer end of the rotary body.

11. The heat pump of claim 1, further comprising:
a shaft slot provided on the outer surface of the shaft to allow the plurality of rotary bodies to be detachably attached thereto,
wherein the shaft slot is provided to surround a center of the rotary body.

12. The heat pump of claim 1, wherein the housing comprises:
a housing body provided to surround the power unit;
a housing front part disposed at a front of the housing body;
a housing rear part disposed at a rear of the housing body; and
a plurality of housing through holes formed through the housing body and the housing front part to allow liquid to flow into and out of the housing body.

13. The heat pump of claim 1, wherein the housing comprises:
a housing body provided to surround the power unit;
a housing recess formed by recessing toward the shaft on an outer surface of the housing body; and
a plurality of housing inlet holes formed through the housing body and the housing recess to allow liquid to flow into and out of the housing body,
wherein the housing inlet holes are formed in a surface of the housing recess facing the rotary body.

14. The heat pump of claim 1, wherein each of the rotary bodies comprises:
a rotary body part defining an external appearance;
a rotary penetration part formed through a center of the rotary body part to be fitted over the shaft;
a rotary outer part spaced apart from the rotary body part, and provided to surround the rotary body part;
a plurality of rotary blades provided between the rotary body part and the rotary outer part, and connecting the rotary body part and the rotary outer part; and
a rotary support part provided to surround the rotary penetration part, and protruding from a center of the rotary body part,
wherein the housing comprises:
a housing body provided to surround the power unit;
a housing front part disposed at a front of the housing body to close the housing body, an inner surface thereof facing the rotary support part;
a housing rear part disposed at a rear of the housing body to close the housing body; and
a housing extension extending from an inner surface of the housing front part toward the rotary penetration part to be disposed inside the rotary support part.

15. The heat pump of claim 1, wherein the housing comprises:
a housing body provided to surround the power unit;
a housing front part disposed at a front of the housing body to close the housing body;
a housing rear part disposed at a rear of the housing body to close the housing body; and
a housing waterproofing part disposed inside the housing body to surround the shaft, thereby separating the motor and the rotary body, and provided to seal the motor.
